(19) United States
(12) Patent Application Publication
(10) Pub. No.: US 2025/0296607 A1
(43) Pub. Date: Sep. 25, 2025

(54) FACILITY AND METHOD FOR MONITORING A RAILROAD CROSSING

(71) Applicant: Siemens Mobility GmbH, München (DE)

(72) Inventor: Jens Braband, Braunschweig (DE)

(21) Appl. No.: 19/085,039

(22) Filed: Mar. 20, 2025

(30) Foreign Application Priority Data
Mar. 20, 2024 (EP) 24164692.6

(51) Int. Cl. B61L 23/00; G06V 20/54

(52) U.S. Cl. CPC B61L 23/007; G06V 20/54

(57) ABSTRACT

A method monitors a railroad-crossing. A track system area of which, which can be traveled by rail vehicles, and can be traversed by objects along a passing direction. Accordingly, provision is made for a first protection area located in front of the track system area along the passing direction to be monitored for passing events, for a second protection area located behind the track system area along the passing direction to be monitored for passing events, and for at least one warning signal to be generated if the identified passing events are implausible according to at least one predetermined plausibility check.

### CROSS-REFERENCE TO RELATED APPLICATION

This application claims the priority, under 35 U.S.C. § 119, of European Patent Application EP 24164692.6, filed Mar. 20, 2024; the prior application is herewith incorporated by reference in its entirety.

### FIELD AND BACKGROUND OF THE INVENTION

The invention relates to facilities and methods for monitoring a railroad crossing.

Railroad crossings with (full) barriers are typically monitored by personnel or with radar scanners, which require a safety accreditation according to SIL3. With simpler operating conditions, solutions such as a time-controlled closure after a warning (normally closed barriers according to Deutsche Bahn RIL 456.0001) are also permitted.

Published, non-prosecuted German patent application DE 10 2007 032091 B3 describes an apparatus which has an electrical controller, for capturing a frontal side image of a section of road and a frontal view of an object located on the section by means of a camera. A further camera records a hazard area image of a hazard area and/or of the section of track. The controller compares the images with one another until the object is identified in the image. The controller sets a conditional parameter to a value when all objects are identified, wherein the parameter encodes a condition which specifies whether a railroad crossing is curved.

U.S. patent publication No. 2015/323663 A1 describes a method for identifying a hazard area to be monitored on a railroad crossing. The following steps are carried out: arranging at least one radar sensor on the hazard area; determining object trajectories from temporal sequences of object positions of respective objects moving through the hazard area by means of the radar sensor; determining the position of at least one traffic route on the basis of an accumulation of object trajectories; determining the positions of barrier straight lines on the basis of radar reflections of the closed barriers; ascertaining the hazard area by linking information relating to the determined position of the at least one traffic route with information relating to the determined position of the barrier straight lines.

### SUMMARY OF THE INVENTION

The object underlying the invention is to specify a method for monitoring a railroad crossing, which can be used alone to monitor the railroad crossing, and/or in addition to another method can serve as additional protection.

This object is achieved according to the invention by a method having the features according to the independent method claim. Advantageous embodiments of the inventive method are specified in the subclaims.

Accordingly, provision is made according to the invention for a first protection area located in front of the track system area along a predetermined passing direction to be monitored for passing events, a second protection area located behind the track system area along the passing direction to be monitored for passing events, and at least one warning signal to be generated if the identified passing events are implausible according to at least one predetermined plausibility check.

One significant advantage of the inventive method is that this is based on a monitoring of areas outside of the track system area of the railroad crossing; the inventive method can therefore be used to perform a monitoring of precisely this track system area in addition to other monitoring methods that are already available.

The passing events can be identified particularly easily and thus advantageously by evaluating images, for instance computer-assisted evaluation of digital images which are received by one or more video cameras. A computer-assisted evaluation can be based on artificial intelligence, for instance. A decision as to whether object identification is carried out can also include additional information and evaluation methods such as Bayesian methods, for instance.

Provision is made in accordance with the invention for a counter state warning signal to be generated as the warning signal within the scope of the plausibility check or one or the plausibility checks if the number of identified passing events of the first protection area deviates from the number of identified passing events of the second protection area at a predetermined point in time of checking.

It is therefore considered to be advantageous, for instance, if, within the scope of the plausibility check or one of the plausibility checks, the passing events are counted in each case by forming a first counter state, which specifies the number of passing events of the first protection area, and a second counter state, which specifies the number of passing events of the second protection area and a counter state warning signal is generated as the warning signal if the difference between the first counter state and the second counter state is not equal to zero at the predetermined point in time of checking.

The counter states can be set to zero for instance before each opening of the railroad crossing or each approval to pass the railroad crossing in each case.

The predetermined point in time of checking can be any point in time at which the area between the two protection areas, in other words the hazard area or the travelable track system area, is reported as empty by another track system monitoring unit.

Provision can also be made for the predetermined point in time of checking to be a point which lies before an expected or planned travel of the track system area by a rail vehicle. It is particularly advantageous if the predetermined point in time of checking is a point in time after closure of a barrier of the railroad crossing and/or a point in time after a prohibition indicator indicating a passing ban of the railroad crossing. At such a point in time of checking, the railroad crossing should or must be empty; therefore all objects which have entered the hazard area must therefore have left it again so that the difference between the afore-cited first counter state and the afore-cited second counter state must amount to zero.

If, according to intended use, the railroad crossing can be traversed along the passing direction and contrary to the passing direction, then, within the scope of the plausibility check or one of the plausibility checks, the passing events can be counted in a direction-dependent manner in each case and a counter state warning signal can be generated as the warning signal if the number of objects which have moved in the direction of the track system area deviates from the number of objects which have moved away from the track system area at a predetermined point in time of checking.

By way of example, within the scope of the plausibility check or one of the plausibility checks, the passing events can be counted in a direction-dependent manner in each case, namely by forming a first counter state, which specifies the number of passing events of the first protection area along the passing direction, a further first counter state, which specifies the number of passing events of the first protection area contrary to the passing direction, a second counter state, which specifies the number of passing events of the second protection area along the passing direction, a further second counter state, which specifies the number of passing events of the second protection area contrary to the passing direction. In such a case, a counter state warning signal is generated as the warning signal if the difference between the first counter state and the second counter is not equal to zero and/or the difference between the first further and the second further counter state is not equal to zero at the predetermined point in time of checking.

In order to be able to carry out a monitoring of the railroad crossing which is independent of a monitoring of the hazard area, in other words of the track area which can be traveled by the rail vehicles, it is considered to be advantageous if the first protection area is located between the track system area and a barrier or block marker located in front of the track system area viewed along the passing direction and the second protection area is located between the track system area and a barrier or block marker located behind the track system area viewed along the passing direction. If the railroad crossing is blocked because a rail vehicle is imminently passing through, the area between the track area which can be traveled and the barriers or the block marker must be free.

Alternatively or in addition, the monitoring of the railroad crossing can provide that the passing speed is determined in each case for each object passing the first protection area, a time frame in which a passing event of the second protection area would have to be detected is calculated using the determined speed, and an error signal is generated as the warning signal if no passing event of the second protection area is detected within the time frame; because a failure to detect the second passing event indicates an error in the object identification, whether it be with respect to an alleged drive-in event, which has where possible not taken place, or the expected drive-out event which has not been registered.

Alternatively or in addition, the monitoring of the railroad crossing can provide that within the scope of the plausibility check or one or the plausibility checks, an error signal is generated as the warning signal if the difference between the number of passing events identified in the first and second protection area exceeds a predetermined threshold. The last-mentioned plausibility check is based on the idea that the space in the region of the railroad crossing is restricted and for this reason objects cannot be available between the two protection areas in any arbitrary number. The threshold preferably lies at a value of between 5 and 10.

Provision can also be made for the railroad crossing to have at least one first passing lane for the traversing of the track system area along the passing direction and at least one second passing lane for the traversing of the track system area contrary to the passing direction. In such a case, provision can advantageously be made for the first and second protection area to be assigned to the first passing lane, a third protection area to be assigned to the second passing lane, to be located in front of the track system area contrary to the passing direction and to be monitored for passing events, a fourth protection area to be assigned to the second passing lane, to be located behind the track system area contrary to the passing direction and to be monitored for passing events, and for at least one warning signal to be generated if the identified passing events are implausible according to at least one predetermined plausibility check.

With the last-mentioned variant, it is advantageous if, within the scope of the plausibility check or one of the plausibility checks, the passing events are counted by forming a third counter state, which specifies the number of passing events of the third protection area, and a fourth counter state, which specifies the number of passing events of the fourth protection area, and a counter state warning signal is generated as the warning signal if the difference between the third counter state and the fourth counter state is not equal to zero at the predetermined point in time of checking.

Alternatively or in addition, provision can be made for the passing speed to be determined for each object passing the third protection area in each case, for a time frame in which a passing event of the fourth protection area has to be captured to be calculated using the determined speed, and for an error signal to be generated as the warning signal if no passing event of the fourth protection area is detected within the time frame.

Alternatively or in addition, provision can be made for an error signal to be generated as the warning signal within the scope of the plausibility check or one of the plausibility checks if the difference between the third and the fourth counter state exceeds a predetermined threshold.

With respect to the arrangement of the areas, it is advantageous if the third protection area is located between the track system area and a barrier or block marker located behind the track system area in the passing direction and if the fourth protection area is located between the track system area and a barrier or block marker located in front of the track system area in the passing direction.

As already indicated in the introduction, the monitoring of the protection areas can be combined with a monitoring of the hazard area. Accordingly, it is considered advantageous if the track system area which can be traveled by rail vehicles is monitored within the scope of a hazard area monitoring and the monitoring of the first and second protection area is carried out for the purpose of protecting the hazard area monitoring, wherein a checking signal is generated when the or at least one of the warning signals has been generated if a notification of availability of the track system area exists within the scope of the hazard area monitoring.

The invention relates moreover to a monitoring facility for carrying out a method, in particular one such as described above, for monitoring a railroad crossing, the track system area of which, which can be traveled by rail vehicles, can be passed by objects along a predetermined passing direction. With respect to such a monitoring facility, provision is made according to the invention for the monitoring facility to have: an image recording facility, which generates images of a first protection area located in front of the track system area along the passing direction and images of a second protection area located behind the track system area along the passing direction, and an image evaluation facility connected to the image recording facility, which is embodied to monitor the images indicating the first and second protection area for passing events and to generate at least one warning signal if the identified passing events are implausible according to at least one predetermined plausibility check.

With respect to the advantages of the monitoring facility according to the invention and advantageous embodiments of the inventive monitoring facility, reference is to be made to the above embodiments in conjunction with the inventive method and its advantageous embodiments.

It is advantageous if the image evaluation facility has a computing facility, which is programmed with a computer program product, which contains program commands which, upon execution by the computing facility, trigger this to evaluate the images and to carry out the at least one predetermined plausibility check.

The invention relates moreover to a computer program product, in particular for an image evaluation facility. With respect to the computer program product, provision is made in accordance with the invention for this to comprise program commands, which, upon execution by a computing facility, trigger this to monitor images, which indicate a first and second protection area of a railroad crossing, for passing events in each case and to generate at least one warning signal if the identified passing events are implausible according to at least one predetermined plausibility check. With respect to the advantages of the computer program product according to the invention and advantageous embodiments of the computer program product according to the invention, reference should be made to the above embodiments in conjunction with the inventive method and its advantageous embodiments.

Other features which are considered as characteristic for the invention are set forth in the appended claims.

Although the invention is illustrated and described herein as embodied in a facility and method for monitoring a railroad crossing, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIGS. 1-10 are illustrations showing railroad crossings, on a basis of which exemplary embodiments are explained for inventive methods for monitoring railroad crossings; and

FIGS. 11-13 are block diagrams showing exemplary embodiments of inventive monitoring facilities, which are suited to carrying out the inventive method.

### DETAILED DESCRIPTION OF THE INVENTION

For the sake of clarity, the same reference characters are always used for identical or comparable components.

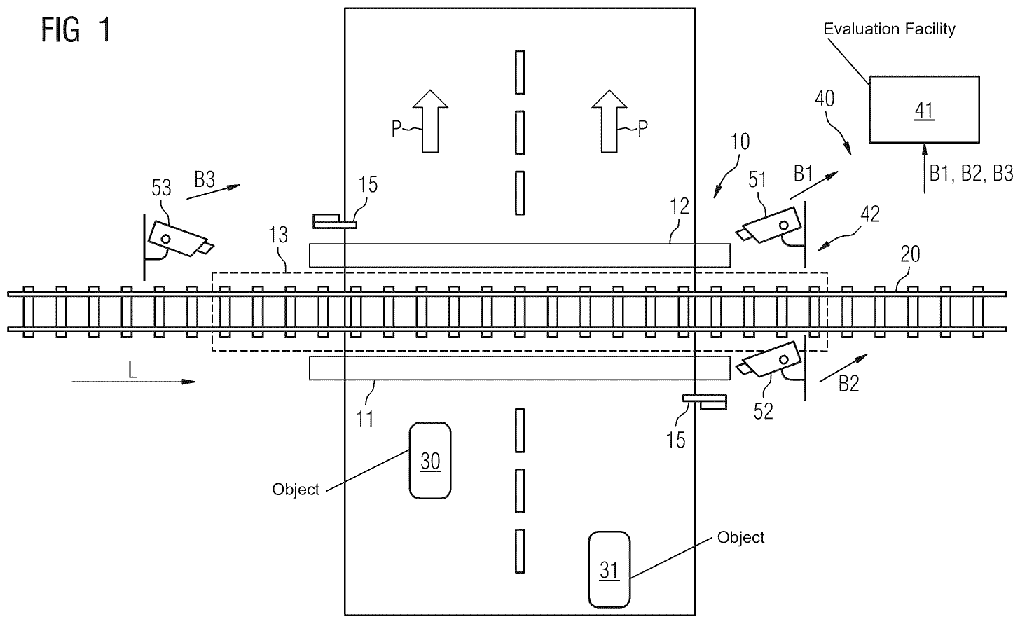

Referring now to the figures of the drawings in detail and first, particularly to FIG. 1 thereof, there is shown a railroad crossing 10 with a track system area 20, which can be traveled by rail vehicles, not shown for the sake of clarity. The track system area 20 can be traversed by objects 30 and 31, such as people, passenger cars, trucks, cyclists etc., which move transversely, for instance at right angles, to the rail longitudinal direction L of the rails of the track system area 20.

By way of example a passing direction P oriented transversely to the rail longitudinal direction L is marked with arrows in FIG. 1, along which passing direction P two objects 30 and 31 traveling on a two-lane one-way road move toward one another in the direction of the railroad crossing 10, in order to traverse the same. Barriers 15 of the railroad crossing 10 are opened at the point in time shown in FIG. 1, so that objects 30 and 31 traverse or pass the railroad crossing 10.

In order to monitor the railroad crossing 10, a monitoring facility 40 is provided, which comprises an image evaluation facility 41 and an image recording facility 42. The image evaluation facility 41 receives images of the image recording facility 42 and evaluates these for the purpose of object identification. For object identification the image evaluation facility 41 can use generally available object identification software, for instance such which uses artificial intelligence trained for object identification.

In the exemplary embodiment according to FIG. 1, the image recording facility 42 has three cameras 51-53, of which a first camera 51 monitors a first protection area 11 assigned to the railroad crossing 10 and generates images B1 indicating this first protection area 11, a second camera 52 monitors a second protection area 12 assigned to the railroad crossing 10 and generates images B2 indicating this second protection area 12, and a third camera 53 monitors a hazard area 13 of the railroad crossing 10 and generates images B3 indicating this hazard area 13. The hazard area 13 comprises the section of the track system, which is traveled by the rail vehicles in the area of the railroad crossing 10 and therefore has to be completely cleared before the rail vehicles are able to travel over the railroad crossing 10.

The first protection area 11, in the exemplary embodiment according to FIG. 1, lies outside of the hazard area 13, namely in front of the hazard area 13 viewed along the passing direction P. The second protection area 12, in the exemplary embodiment according to FIG. 1, likewise lies outside of the hazard area 13, namely along the passing direction P viewed behind the hazard area 13.

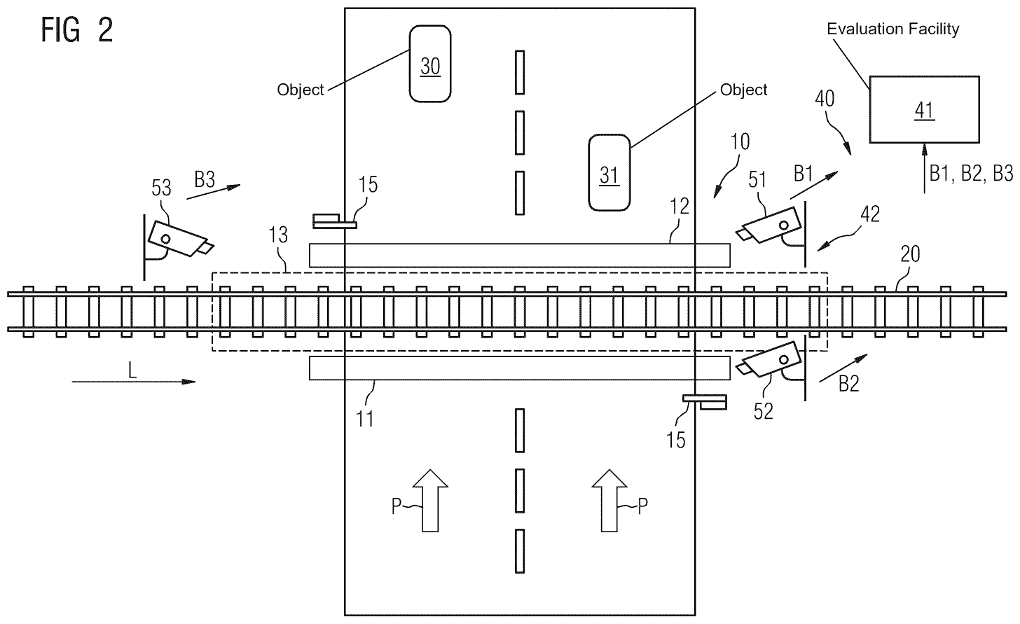

FIG. 2 shows the railroad crossing 10 according to FIG. 1 at a subsequent point in time, at which the two objects 30 and 31 have already passed the railroad crossing 10.

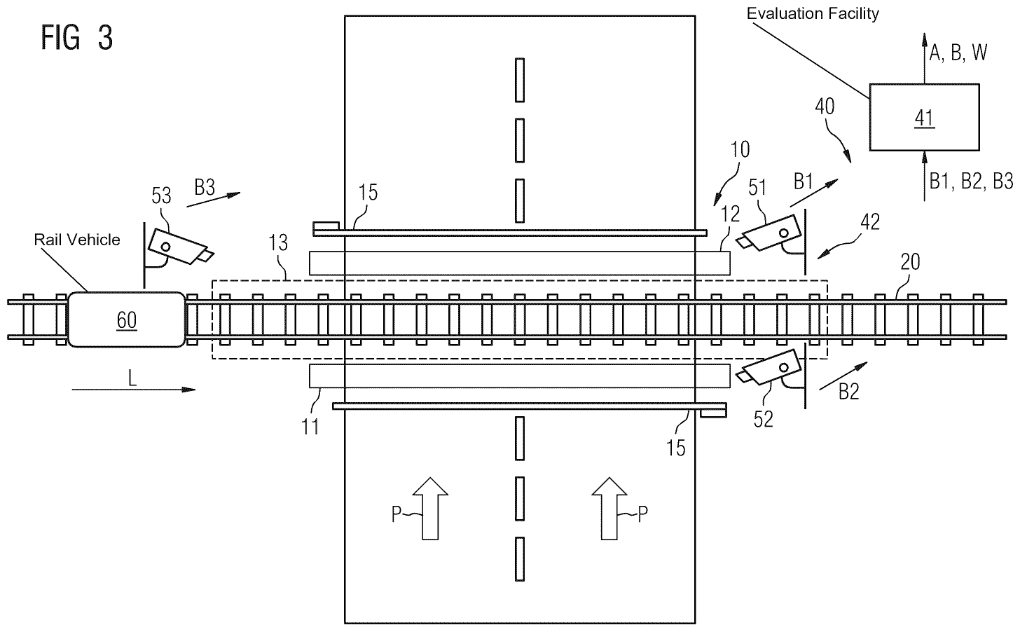

FIG. 3 shows the railroad crossing 10 according to FIGS. 1 and 2 at an even later point in time, at which the barriers 15 of the railroad crossing 10 are closed and a drive-in of a rail vehicle 60 is imminent. It is clear that the first and second protection area 11 and 12 lie between one of the barriers 15 and the hazard area 13 in each case.

The railroad crossing 10 or the monitoring facility 40 are preferably operated as now described.

Provided the railroad crossing 10 is opened or a traversing of the railroad crossing 10 is permitted, the monitoring facility 40 monitors the first and second protection area 11 and 12 for crossing events, by evaluating the images B1 and B2 of the first and second camera 51 and 52. The image evaluation comprises here the identification of objects such as for instance the objects 30 and 31. Subsequently, it is assumed by way of example that, according to intended use, the railroad crossing 10 should only be passed along the passing direction P marked with the arrow.

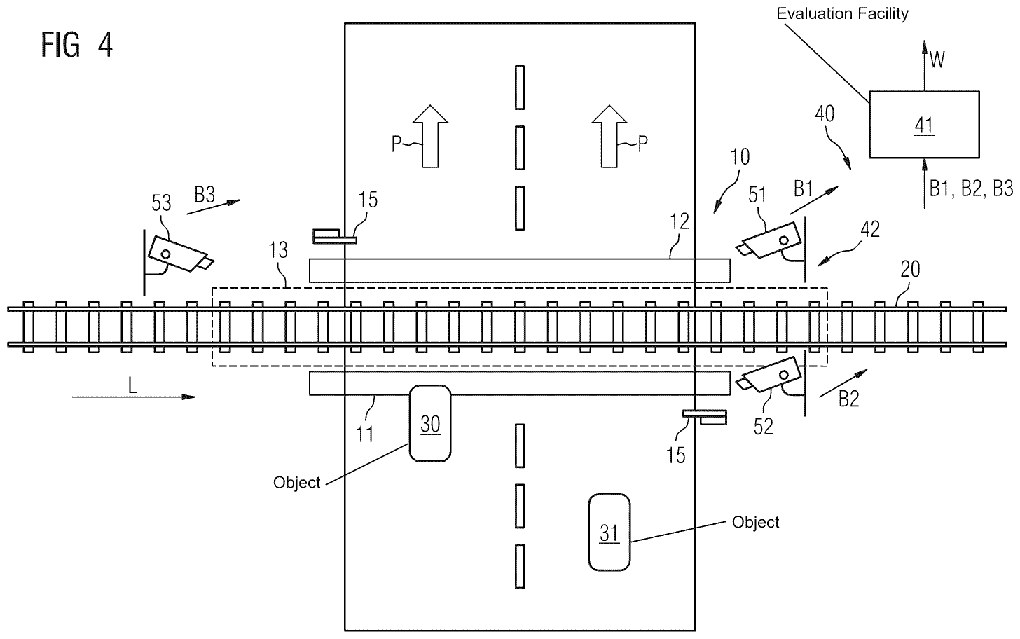

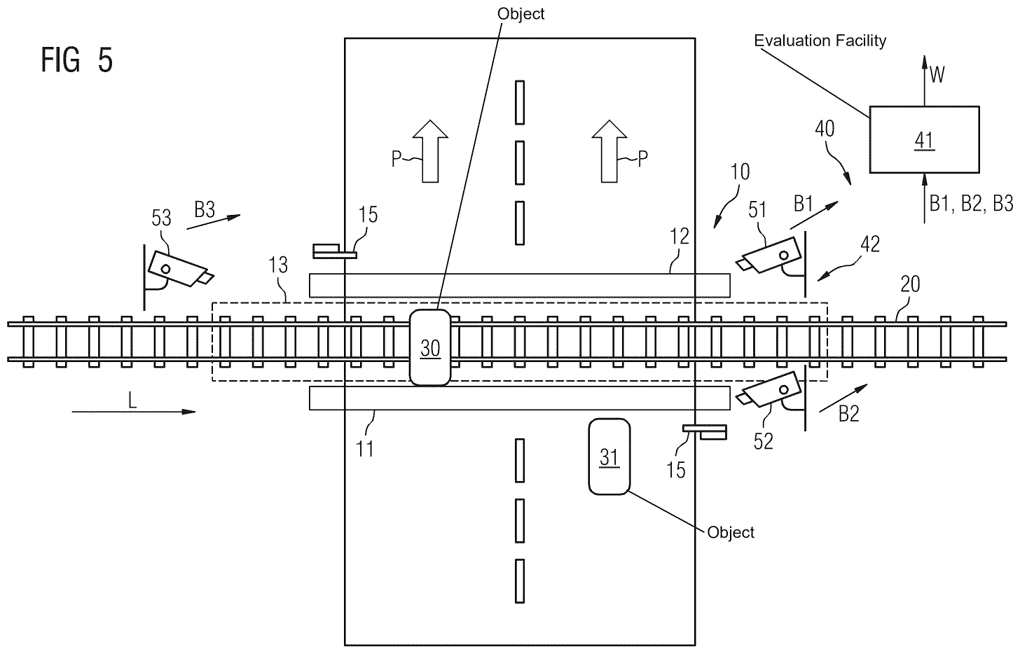

In such a case, it is sufficient if the monitoring facility 40 detects a crossing event in the first protection area 11 and thus a drive-in event in the railroad crossing 10 in each case, if it detects an object (see for instance object 30 in FIG. 4) in the first protection area 11 at a drive-in point in time and no longer identifies the corresponding object 30 in the first protection area 11 at a subsequent drive-out point in time (see FIG. 5). Correspondingly, the monitoring facility 40 can detect all objects entering the railroad crossroad 10 and count them by forming a first counter state, which specifies the number of passing events of the first protection area 11 and thus the objects entering the hazard area 13.

The monitoring facility 40 preferably counts a crossing event or a drive-in event in each case if the previously identified object 30 has left the first protection area 11 again. Since, in the exemplary embodiment according to FIGS. 1 to 5, a one-way road operation is assumed by way of example, a directional identification of the movement of the identified objects 30 and 31 is not required here.

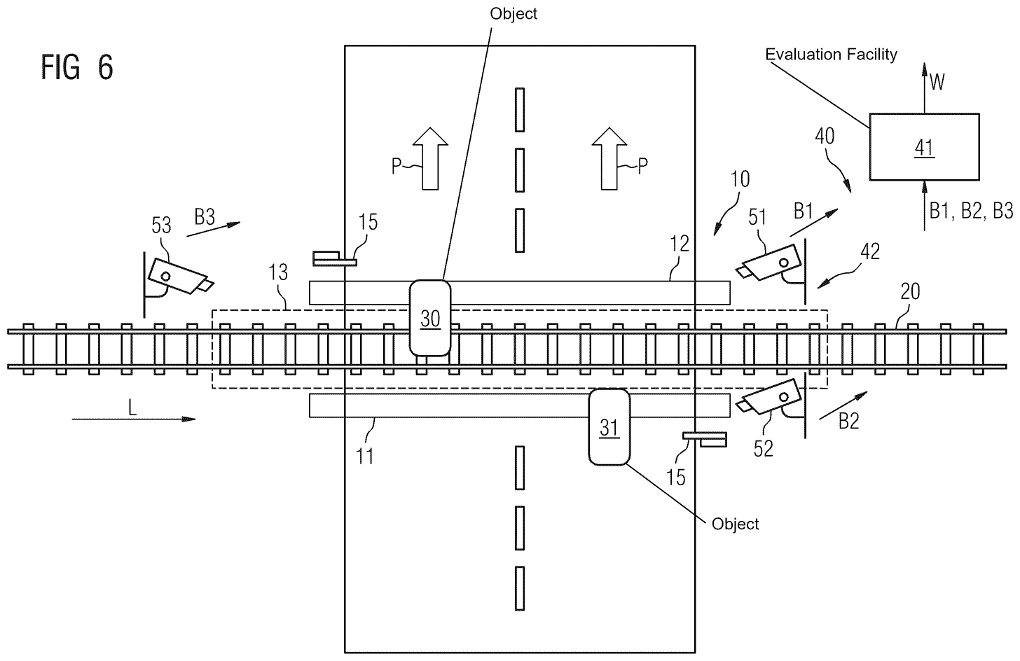

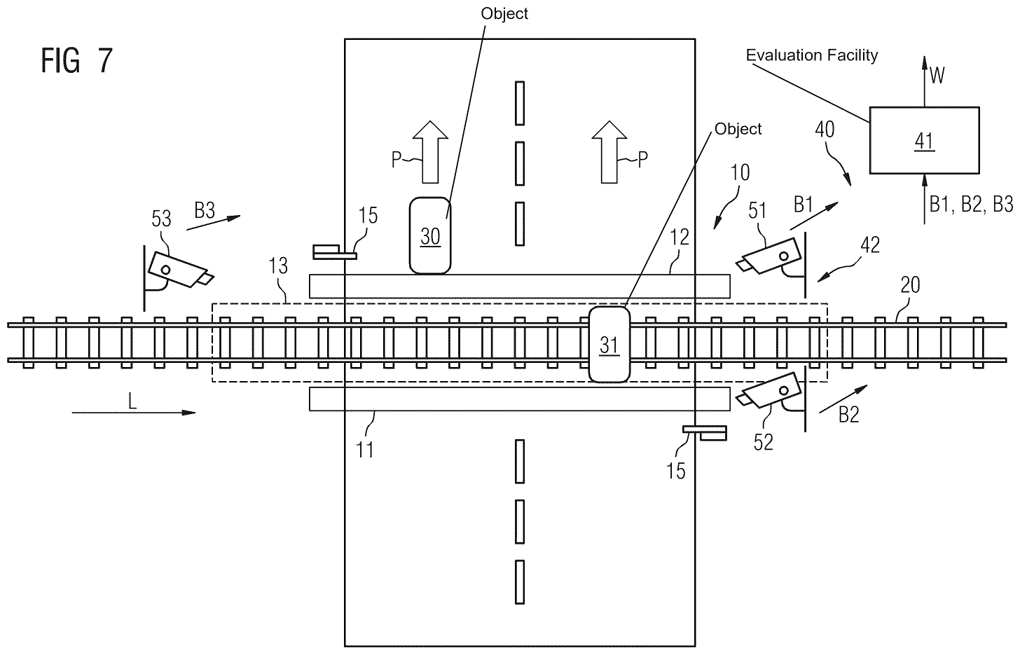

Similarly, the monitoring facility 40 can capture a crossing event in the second protection area 12 in each case and thus a drive-out event from the railroad crossing 10, if it detects an object (see object 30 in FIG. 6) in the second protection area 12 at one point and no longer identifies the corresponding object 30 in the second protection area 12 at a subsequent later drive-out point in time (see FIG. 7).

Correspondingly, the monitoring facility 40 can capture all objects leaving the railroad crossing 10 and count them by forming a second counter state, which specifies the number of passing events of the second protection area 12 and thus the number of those objects which have left the hazard area 13 again. The monitoring facility 40 here counts a crossing event or a drive-out event preferably likewise when the previously identified object has left the second protection area 12 again. Since, with the exemplary embodiment according to FIGS. 1 to 7, a one-way road operation is assumed by way of example, a directional identification of the movement of the identified objects is also no longer necessary during the drive-out identification.

Again, with reference to FIG. 3, which shows the railroad crossing 10 with closed barriers 15 and before the rail vehicle 60 drives in, the monitoring facility 40 can check, after the barrier has closed, using the images of the third camera 53, which shows the hazard area 13, whether one or more objects are located in the hazard area 13. If this is the case, the monitoring facility 40 generates an alarm signal A, with which by way of example a drive-in of the rail vehicle 60 into the hazard area 13 is stopped or another safety measure is triggered.

If the monitoring facility 40 is not able to identify any objects in the hazard area 13 using the images B3 of the third camera 53 indicating the hazard area 13, for the purpose of further protecting the driving operation, it checks the first counter state, which specifies the counted drive-in events in the hazard area 13, and the second counter state, which specifies the counted drive-out events from the hazard area 13. If there are actually no objects located in the hazard area 13, the difference between the two counter states must amount to zero; if this is the case, as shown in FIG. 3, the monitoring facility 40 can generate a confirmation signal BS which explicitly confirms an exemption of the hazard area 13.

If the counter state is not zero at this point, however, an error occurs, be it that the hazard area monitoring or the evaluation of the images B3 showing the hazard area 13 has failed or the monitoring of the protection areas 11 and 12 additionally performed as a support measure has determined an incorrect result. In such a case, the monitoring facility 40 preferably generates a warning signal W which indicates that an implausible object identification has taken place and triggers a safety measure.

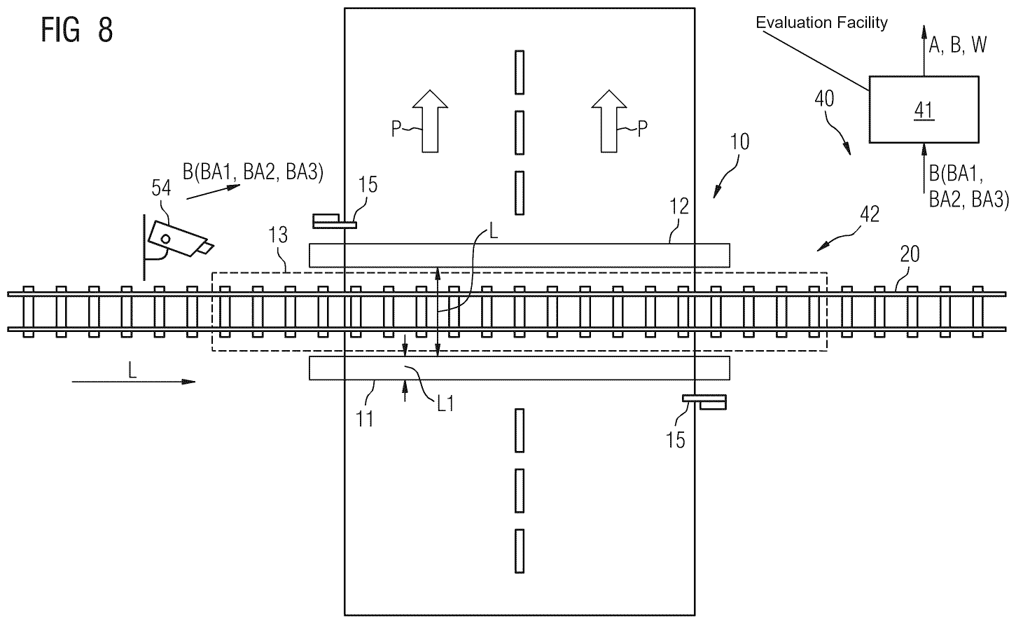

In the exemplary embodiment according to FIGS. to 7, the image recording facility 42 contains the three cameras 51-53, so that the image evaluation facility 41 has the images B of these three cameras 51-53 available to it for the purpose of object identification. Alternatively, provision can be made for the image recording facility 42 only to comprise a single camera 54, the images B of which show the hazard area 13 and the two protection areas 11 and 12. In the last-mentioned case, which is shown in FIG. 8, the image evaluation facility 41 will evaluate the respective image sections, in other words an image section BA1 of the images B showing the first protection area 11 for object identification in the first protection area 11, an image section BA2 of the images B showing the second protection area 12 for object identification in the second protection area 12 and an image section BA3 of the images B3 showing the hazard area 13 for object identification in the hazard area 13.

Irrespective of the number of cameras, it is advantageous if the monitoring facility 40 determines the passing speed for each object 30 passing the first protection area 11 in each case. The monitoring facility 40 can calculate the passing speed by way of example according to

$$V = L 11 / ( Ti - To )$$

wherein Ti refers to the point that the object penetrates the first protection area 11, To refers to the point in time that the object leaves the first protection area 12, L11 refers to the length of the first protection area 11 viewed along the passing direction P and V refers to the speed.

On the basis of the determined speed V, the monitoring facility 40 calculates a time frame in which a passing event has to be detected in the second protection area 12, for instance according to:

$$( V * L ) - T t < d T < ( V * L ) + T t$$

wherein dT refers to the time frame, L refers to the spatial distance between, viewed along the passing direction P, the end of the first protection area 11 and the start of the second protection area 12 and Tt refers to a tolerance value.

If the monitoring facility 40 does not detect a passing event in the second protection area 12 within the time frame dT—by including the predetermined temporal tolerance value Tt, it preferably likewise generates a warning signal W.

The monitoring facility 40 can also generate an error signal as a warning signal W, if the difference between the counter states exceeds a predetermined threshold. This error signal generation is based on the idea that the number of objects, which can be located in the hazard area 13, is restricted solely for space reasons, so that an excessively high counter state difference indicates a technical problem at any point in time, in other words independent of the closing state of the barrier 15.

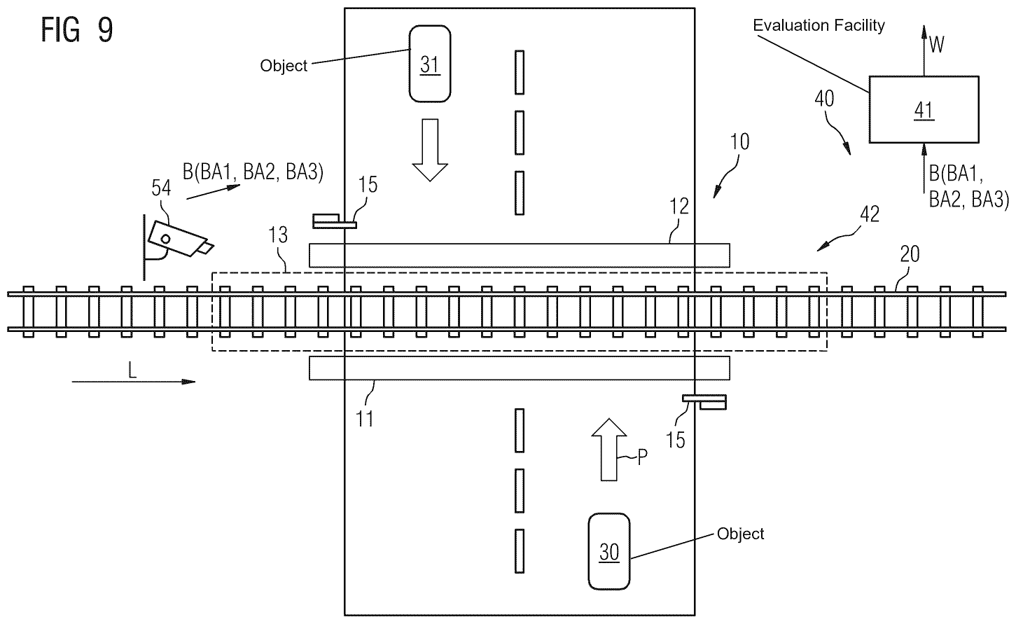

A two-lane road is shown by way of example in FIG. 9, which, according to intended use, can be traveled on a first, right travel lane in FIG. 9 along the passing direction P according to FIG. 1 and, according to intended use, on a second left travel lane in FIG. 9, contrary to the passing direction P.

In order to enable the above-described plausibility check with just one protection area 11—viewed along the passing direction P—in front of the hazard area 13 and only one protection area 12 behind the hazard area 13, the monitoring facility 40 also evaluates the passing events in a direction-dependent manner in each case.

By way of example, the monitoring facility 40 can generate a first net counter state, which specifies the objects entering the hazard area 13 by way of the first protection area 11 minus the objects leaving the hazard area 13 by way of the second protection area 12. Correspondingly, the monitoring facility 40 can generate a second net counter state, which specifies the objects entering the hazard area 13 by way of the second protection area 12 minus the objects leaving the hazard area 13 by way of the first protection area 11.

If no objects are actually located in the hazard area 13, the two net counter states must amount to zero in each case.

If one of the net counter states is not zero, however, the hazard area monitoring unit must indicate at least one object 30 in the hazard area 13; if this is not the case, an error exists and a warning signal W is generated, preferably independently of the point in time, but at least when the described situation is established after the barriers 16 are closed.

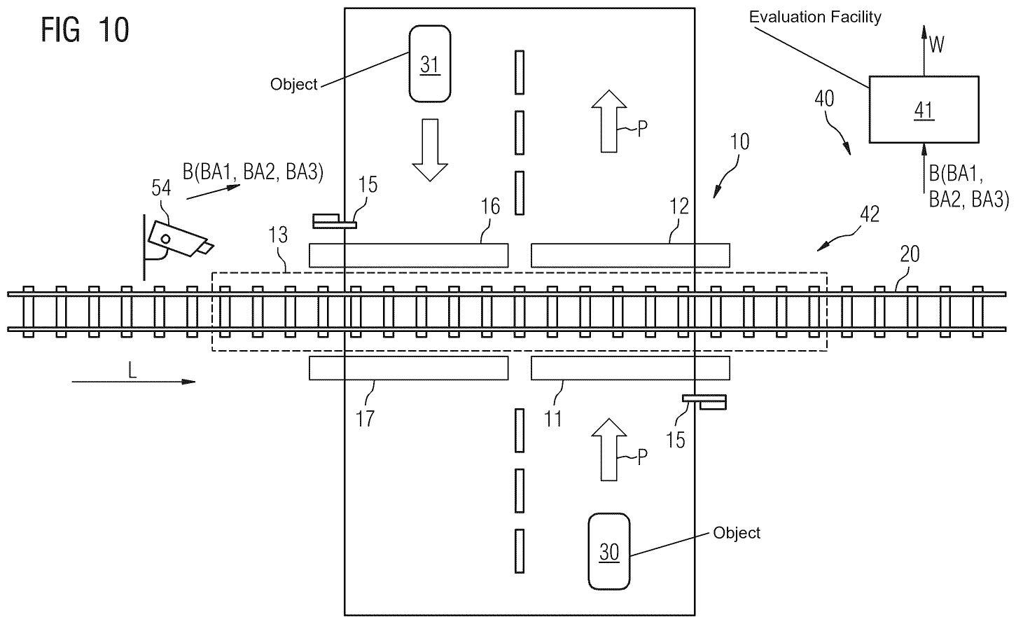

A two-lane road is shown by way of example in FIG. 10, which, according to intended use, can be traveled on a first, left driving lane in FIG. 10 along the passing direction P according to FIG. 1 and, according to intended use, on a second right travel lane in FIG. 10, contrary to the passing direction, and in which each of the two travel lanes is equipped with a pair of protection areas in each case.

The first passing lane is equipped with the first and second protection area 11, 12; in this regard the protection of the hazard space monitoring of the hazard area 13 is carried out, as explained above in conjunction with the FIGS. 1 to 9 with or without directional identification of the movement direction of the objects.

The second passing lane is equipped with a third and fourth protection area 16 and 17; in this regard the protection of the hazard space monitoring is carried out, as was explained above in conjunction with the first and second protection area 11 and 12 or FIGS. 1 to 9 (with or without directional identification of the movement direction of the objects); in this regard the above explanations apply in conjunction with the first protection area 11 similarly to the third protection area 16 and the above explanations in conjunction with the second protection area 12 similarly to the fourth protection area 17.

A direction-dependent movement identification can be carried out for each pair of protection areas 11 and 12 or 16 and 17 in each case by forming net counter states, as has been explained above.

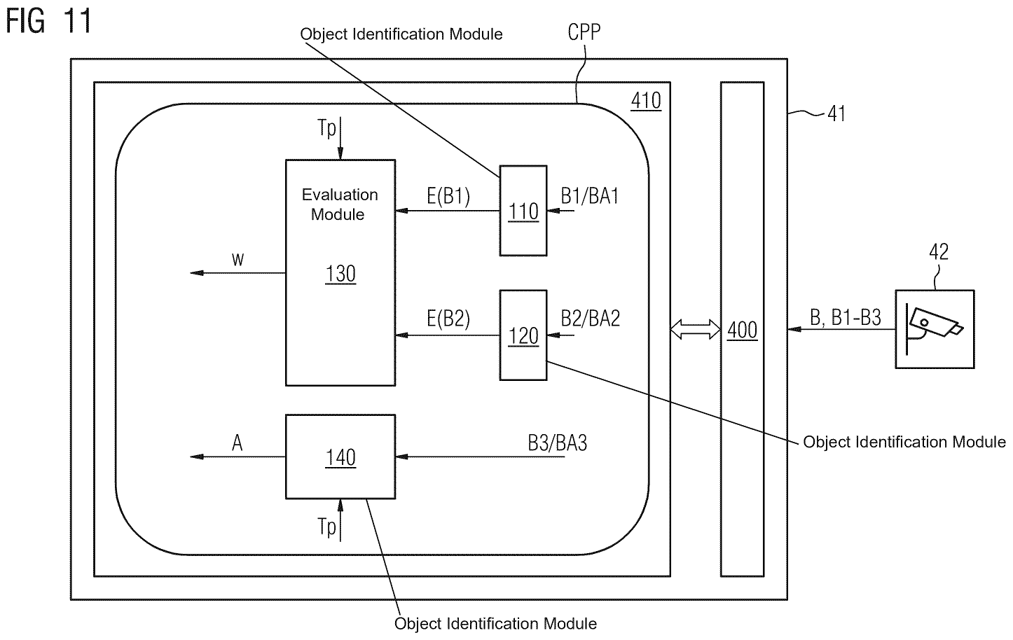

FIG. 11 shows an exemplary embodiment of a monitoring facility 40, which is suited to implementing the monitoring method described in conjunction with FIGS. 1 to 10, and its image evaluation facility 41 in more detail. The image evaluation facility 41 processes digital images of a digitally operating image recording facility 42.

The image evaluation facility 41 comprises a computing facility 400 and a storage unit 410. A computer program product CPP is stored in the storage unit 410, the program commands of which determine or at least codetermine the mode of operation of the computing facility 400 and thus that of the image evaluation facility 41 during execution by the computing facility 400.

The computer program product CPP comprises a first object identification module 110, which is embodied to identify objects in the images B1 of the first camera 51 according to FIG. 1 or in the image section BA1 of the images B of the camera 53 indicating the first protection area 11 according to FIGS. 8 to 10. As soon as the first object identification module 110 identifies an object in the first protection area 11 and this leaves the first protection area 11 again, the object identification module 110 therefore generates a passing event message E, which indicates a passing event in the first protection area 11.

To avoid such passing event messages E, when an object penetrates the first protection area 11 from outside of the area of the railroad crossing 10 and leaves this again outward, in other words not in the direction of the hazard area 13, a movement-dependent object identification can be provided and the generation of passing event messages E can be restricted to such cases in which an identified object leaves the first protection area 11 in the direction of the hazard area 13. The passing event messages E are forwarded to a subordinate evaluation module 130 of the computer program product CPP.

The computer program product CPP moreover contains a second object identification module 120, which is embodied for object identification in images B2 of the second camera 52 according to FIG. 1 or in the image section BA2 of the images of the camera 54 showing the second protection area 12 according to FIGS. 8-10. As soon as the second object identification module 120 identifies an object and this leaves the second protection area 12 again, the second object identification module 120 generates a passing event message E, which indicates a passing event in the second protection area 12. In order to avoid such passing event messages E, when an object penetrates the second protection area 12 from outside of the area of the railroad crossing 10 and leaves this again outward, in other words not in the direction of the hazard area 13, a movement-dependent object identification can be provided and the generation of passing event messages E can be restricted to such cases in which an identified object coming from the hazard area 13 leaves the second protection area 12 in the direction of the hazard area 13. The passing event messages E of the second object identification module 120 are forwarded to the subordinate evaluation module 130.

The evaluation module 130 compares the number of passing event messages E of the first object identification module 110 with those of the second object identification module 120 and generates a warning signal W when the difference between the numbers is not equal to zero at a predetermined point in time of checking Tp. By way of example, the predetermined point in time of checking Tp is a point in time after closure of the barrier 15 of the railroad crossing 10 or a point in time after a prohibition indicator indicating a passing ban of the railroad crossing 10, in other words a point in time at which no objects are permitted to be located in the hazard area 13 or between the first and second protection area 11 and 12 during a correct operating procedure.

In addition, the evaluation module 130 can also generate a warning signal at any other point in time, when the difference between the counter states, specifically the difference between the number of passing events identified in the first and second protection area 11 or 12, exceeds a predetermined threshold, which is greater than zero. The threshold preferably corresponds to the maximum number of objects which is to be expected during a normal operating procedure in the area of the railroad crossing 10. The threshold can amount to ten, for instance.

Alternatively or in addition, the evaluation module 130 can be programmed to determine the passing speed for each object 30 passing the first protection area 11, to calculate a time frame in which a passing event of the second protection area 12 has to be captured using the determined speed, and to generate an error signal as a warning signal, when no passing event is detected in the second protection area 12 within the time frame.

The computer program product CPP moreover contains a third object identification module 140, which is embodied for object identification in the images B3 of the third camera 53 according to FIG. 1 or in the image section BA3 of the images of the camera 54, indicating the hazard area 13, in accordance with FIGS. 8-10. If the third object identification module 140 still identifies an object in the hazard area 13 at the cited point in time of checking at which no object is permitted to be identified because the railroad crossing 10 is closed, the third object identification module 140 generates an alarm signal A.

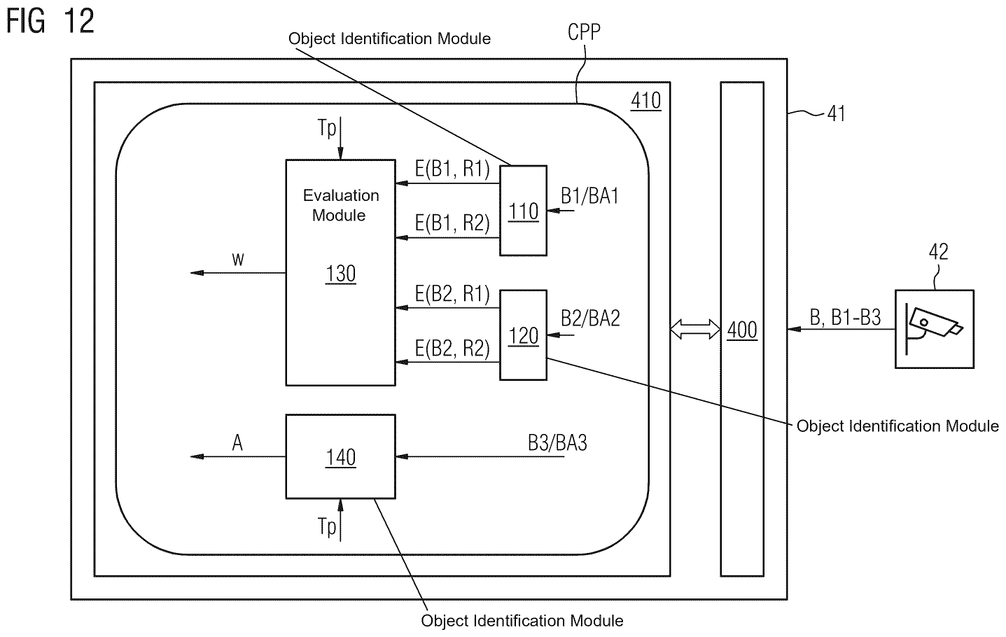

FIG. 12 shows a further exemplary embodiment for an image evaluation facility 41, which is suited to carrying out the monitoring method described in conjunction with FIGS. 1 to 10. In the exemplary embodiment according to FIG. 12, the first and second object identification module 110 and 120 detect the passing events in a direction-dependent manner in each case and notify each passing event with a direction indicator R1 or R2 specifying the respective passing direction. The direction indicator R1 specifies a movement along the passing direction P in FIG. 1 and the direction indicator R2 specifies a movement contrary to this passing direction P.

The evaluation module 130 compares the number of passing event messages E of the first object identification module 110, which have the direction indicator R1, with those of the second object identification module 120, which have the same direction indicator R1, and generates a warning signal W when the difference between these is not equal to zero at the predetermined point in time of checking Tp or exceeds the afore-cited threshold of ten at any other point in time, for instance.

Correspondingly, the evaluation module 130 processes the passing event messages E of the first and second object identification module 110 and 120, which have the direction indicator R2, and generates a warning signal W when the difference between these is not equal to zero at the predetermined point in time of checking Tp or exceeds the afore-cited threshold of ten at any other point in time, for instance.

Incidentally, in conjunction with the exemplary embodiment according to FIG. 11, the above explanations apply to the exemplary embodiment according to FIG. 12.

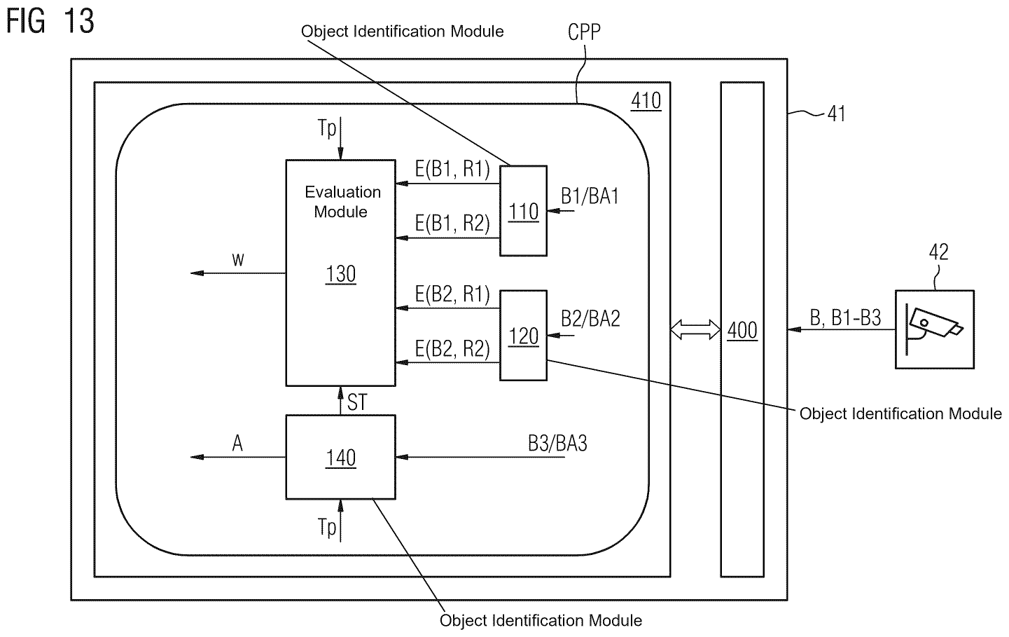

The implementation of a plausibility check can also be triggered by the evaluation module 130 by means of a control signal ST (see FIG. 13). By way of example, the evaluation module 130 can have a control signal ST in each case, if it is established that the hazard area 13 is free.

Finally, it should be mentioned that the features of all the above-described exemplary embodiments can be combined arbitrarily with one another in order to form further other exemplary embodiments of the invention.

All features of subclaims can also be combined per se with each of the subordinate claims in each case, namely per se separately or in any combination with one or more other subclaims in each case, in order to obtain further other exemplary embodiments.

Independent of the grammatical term usage, individuals with male, female or other gender identities are included within the term.

The following is a summary list of reference numerals and the corresponding structure used in the above description of the invention:
10 Railroad crossing
11-12 Protection areas
13 Hazard area
15 Barrier
16-17 Protection areas
20 Track system area
30 Object
31 Object
40 Monitoring facility
41 Image evaluation facility
42 Image recording facility
51-54 Cameras
60 Rail vehicle
110 Object identification module
120 Object identification module
140 Object identification module
130 Evaluation module
400 Computing facility
410 Storage unit
A Alarm signal
B Images
B1-B3 Images
BA1-BA3 Image section
BS Actuation signal
CPP Computer program product
E Passing event message
L Rail longitudinal direction
P Passing direction
R1 Direction indicator
R2 Direction indicator
ST Control signal
Tp Point in time of checking
W Warning signal

1. A method for monitoring a railroad crossing, a track system area of the railroad crossing, which is traveled by rail vehicles, is traversed by objects along a passing direction, the method comprises the steps of:
monitoring a first protection area disposed in front of the track system area along the passing direction for passing events;
monitoring a second protection area disposed behind the track system area along the passing direction for the passing events; and
generating at least one warning signal if identified passing events are implausible according to at least one predetermined plausibility check, wherein within a scope of the at least one predetermine plausibility check or one of a plurality of plausibility checks, a counter state warning signal is generated as the at least one warning signal if a number of the identified passing events of the first protection area deviates from a number of the identified passing events of the second protection area at a predetermined point in time of checking.

2. The method according to claim 1, wherein within the scope of the at least one predetermined plausibility check or one of the plausibility checks, the passing events are counted in a direction-dependent manner in each case, and the counter state warning signal is generated as the at least one warning signal if a number of the objects which have moved in the direction of the track system area deviates from a number of the objects which have moved away from the track system area at the predetermined point in time of checking.

3. The method according to claim 1, wherein within the scope of the at least one predetermined plausibility check or one of the plausibility checks, the passing events are counted in a direction-dependent manner in each case, namely by forming:
a first counter state, which specifies a number of the passing events of the first protection area along the passing direction;
a further first counter state, which specifies a number of the passing events of the first protection area contrary to the passing direction;
a second counter state, which specifies a number of the passing events of the second protection area along the passing direction;
a further second counter state, which specifies a number of the passing events of the second protection area contrary to the passing direction, and the counter state warning signal being generated as the at least one warning signal if a difference between the first counter state and the second counter is not equal to zero and/or a difference between the first further and the second further counter state is not equal to zero at the predetermined point in time of checking.

4. The method according to claim 1, wherein the predetermined point in time of checking is a point in time which is before an expected or planned traveling on the track system area by a rail vehicle.

5. The method according to claim 1, wherein:
the first protection area is disposed between the track system area and a first barrier or block marker disposed in front of the track system area viewed along the passing direction; and
the second protection area is disposed between the track system area and a second barrier or block marker disposed behind the track system area viewed along the passing direction.

6. The method according to claim 1, which further comprises:
determining a passing speed for each object passing the first protection area in each case;
detecting a time frame in which a passing event of the second protection area would have to be detected using the passing speed determined; and
generating an error signal as the at least one warning signal if no said passing event of the second protection area is detected within the time frame.

7. The method according to claim 1, wherein within the scope of the at least one predetermined plausibility check or one of the plausibility checks, generating an error signal as the at least one warning signal if a difference between a number of the passing events identified in the first protection area and the second protection area exceeds a predetermined threshold.

8. The method according to claim 1, wherein:
the railroad crossing has at least one first passing lane for traversing of the track system area along the passing direction and at least one second passing lane for traversing of the track system area contrary to the passing direction;
the first and second protection area are assigned to the first passing lane;
a third protection area is assigned to the second passing lane, is disposed in front of the track system area contrary to the passing direction and is monitored for the passing events;
a fourth protection area is assigned to the second passing lane, is disposed behind the track system area contrary to the passing direction and is monitored for the passing events; and
the at least one warning signal is generated if the identified passing events are implausible according to the at least one predetermined plausibility check.

9. The method according to claim 8, wherein:
within the scope of the at least one predetermined plausibility check or one of the plausibility checks, the passing events are counted in each case by forming a third counter state, which specifies a number of the passing events of the third protection area and a fourth counter state, which specifies a number of the passing events of the fourth protection area, and the counter state warning signal is generated as the at least one warning signal if a difference between the third counter state and the fourth counter state is not equal to zero at the predetermined point in time of checking; and/or
for each object passing the third protection area, a passing speed is determined in each case, a time frame is calculated using the passing speed, in which the passing event of the fourth protection area has to be captured, and an error signal is generated as the at least one warning signal if no said passing event of the fourth protection area is captured within the time frame; and/or
within the scope of the plausibility check or one of the plausibility checks, a further error signal is generated as the at least one warning signal if a difference between the third and the fourth counter state exceeds a predetermined threshold.

10. The method according to claim 8, wherein the third protection area is disposed between the track system area and a barrier or block marker disposed behind the track system area in the passing direction and the fourth protection area is disposed between the track system area and a further barrier or block marker located in front of the track system area in the passing direction.

11. The method according to claim 1, which further comprises:
monitoring the track system area which is traveled by the rail vehicles within a scope of hazard area monitoring;
carrying out the monitoring of the first and second track system area for a purpose of protecting the hazard area monitoring; and
generating a checking signal if a notification of availability of the track system area exists within the scope of the hazard area monitoring if the at least one warning signal has been generated.

12. A monitoring facility for monitoring a railroad crossing having a track system area which is traveled by rail vehicles, and is passed by objects along a predetermined passing direction, the monitoring facility comprising:
an image recorder for generating images of a first protection area disposed in front of the track system area along the predetermined passing direction and images of a second protection area disposed behind the track system area along the predetermined passing direction; and
an image evaluator connected to said image recorder and embodied to monitor the images indicating the first and second protection areas for passing events and to generate at least one warning signal if identified passing events are implausible according to at least one predetermined plausibility check.

13. The monitoring facility according to claim 12, wherein said image evaluator has a computer, which is programmed with a computer program product, which comprises computer executable commands, which, upon execution by said computer, trigger said computer to evaluate the images and to carry out the at least one predetermined plausibility check.

14. A non-transitory computer program product having computer executable instructions, which upon execution by said computer, trigger said computer to monitor images, which indicate a first and second protection area of a railroad crossing, for passing events in each case and to generate at least one warning signal if identified passing events are implausible according to at least one predetermined plausibility check.
